(19) United States
(12) Patent Application Publication
(10) Pub. No.: US 2025/0324302 A1
(43) Pub. Date: Oct. 16, 2025

(54) METHODS AND APPARATUS FOR ADAPTIVE ROLL-BACK AFTER POWER SAVING PREDICTIONS FROM AI/ML MODELS

(71) Applicants: Ashutosh Tiwari, Bengaluru (IN); Vaibhav Singh, Delhi (IN)

(72) Inventors: Ashutosh Tiwari, Bengaluru (IN); Vaibhav Singh, Delhi (IN)

(21) Appl. No.: 19/251,414

(22) Filed: Jun. 26, 2025

(30) Foreign Application Priority Data
Apr. 11, 2025 (IN) 202541035475

(51) Int. Cl. H04W 24/08; G06F 1/3209; H04W 52/02

(52) U.S. Cl. CPC H04W 24/08; G06F 1/3209; H04W 52/0206

(57) ABSTRACT

Systems, apparatus, articles of manufacture, and methods for adaptive roll-back of incorrect power saving predictions from AI/ML models are disclosed. Example instructions cause programmable circuitry to identify a cell to be transitioned to a reduced power state, the identification of the cell based on a message from a radio access network intelligent controller application (rAPP), cause storage of information representing an initial power state of the cell, compute an intermediate power state for the cell, the intermediate power state intermediate a current power state of the cell and the reduced power state of the cell, cause a node to transition the cell to the intermediate power state, analyze a performance report from the node to detect a degradation in quality of service, cause the cell to revert to the initial power state.

### RELATED APPLICATION

This patent claims the benefit of India Provisional Patent Application No. 202541035475, which was filed on Apr. 11, 2025. India Provisional Patent Application No. 202541035475 is hereby incorporated herein by reference in its entirety. Priority to India Provisional Patent Application No. 202541035475 is hereby claimed.

### BACKGROUND

Network operators seek to provide communications services to users using their communication networks. As network complexity increases with the proliferation of IoT devices, smartphones, and advanced connectivity requirements, network operators have looked to machine learning systems to assist in management of the communication networks.

### BRIEF DESCRIPTION OF THE DRAWINGS

FIG. 1 is a block diagram of an example environment in which an example adaptive power control circuitry constructed in accordance with teachings of this disclosure operates to provide adaptive roll-back of incorrect power savings decisions from AI/ML prediction models.

FIG. 2 is a block diagram of an example implementation of the adaptive power control circuitry of FIG. 1 to provide adaptive roll-back of incorrect power savings decisions from AI/ML prediction models.

FIG. 3 is a sequence diagram illustrating an example flow of events for a cell off event.

FIG. 4 is a sequence diagram illustrating an example flow of events for a cell on event.

FIG. 5 is a graph illustrating power states over time in response to an instruction to reduce transmission power.

FIG. 6 is a diagram illustrating an example reinforcement learning (RL) approach to computing an amount of power to be reduced.

FIG. 7 is a flowchart representative of example machine readable instructions and/or example operations 700 that may be executed, instantiated, and/or performed by programmable circuitry to gradually decrease transmission power to a desired level (e.g., an “off” state).

FIG. 8 is a flowchart representative of example machine readable instructions and/or example operations 800 that may be executed, instantiated, and/or performed by programmable circuitry to increase transmission power to a desired level (e.g., an “on” state).

FIG. 9 is a flowchart representative of example machine readable instructions and/or example operations that may be executed, instantiated, and/or performed by programmable circuitry to cause the adaptive power control circuitry to perform a rollback procedure.

FIG. 10 is a block diagram of an example processing platform including programmable circuitry structured to execute, instantiate, and/or perform the example machine readable instructions and/or perform the example operations of FIGS. 7, 8, and/or 9 to implement the adaptive power control circuitry of FIGS. 1 and/or 2.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 7, 8, and/or 9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Known machine learning (ML) has enabled network operators to analyze vast datasets and derive insights for the use and/or operation of their communication network(s). By leveraging these known ML algorithms, network operators can predict congestion, improve (e.g., optimize) resource allocation, detect anomalies in real-time or near real-time, and enhance security. This known approach seeks to improve network performance, reduce operational costs, and improve customer satisfaction through faster speeds and reliability. Unfortunately, known ML algorithms can sometimes make decisions that adversely affect customer satisfaction and/or operational characteristics of the communication network(s).

Network operators currently spend about 20-40% of their expenses on network energy costs. Previously, one of the most popular techniques of energy savings in telecom networks involved relinquishing resources or pushing different network components into sleep states during periods of reduced traffic on the network. Network components can include a radio unit of a cell, massive multiple-input-multiple-output (MIMO) antenna arrays, central processing unit (CPU) cores that support radio area network (RAN) and/or core network operations. These known types of energy saving solutions usually employ load estimation, quality of service (QoS) estimation, etc. (based on AI/ML predictions) for the near future and take necessary power-saving actions when such actions are predicted to be beneficial. Unfortunately, the known solutions have significant shortcomings in dealing with the effects of incorrect and/or wrong predictions from the AI/ML models. If the prediction by the AI/ML model is inaccurate, and the network chooses to follow the recommendation to release resources and/or put the components into sleep states, there may be a degradation in the QoS for the end users. In other words, some existing network energy-saving schemes can cause sudden quality of service degradation and/or even service level agreement (SLA) violation(s).

Examples disclosed herein provide an adaptive scheme to achieve energy savings in a network, while enabling the network to rollback to a stable state, if needed. As a result, the adaptive energy-saving actions of examples disclosed herein have a minimal impact on the QoS of the end-users, while saving sufficient power. Moreover, some such examples are suitable to implement over a controller platform, such as RIC running on Intel Architecture.

Traditional ways of relinquishing resources include switching off a cell, modifying the antenna array to a lower count, and instructing CPU cores to enter sleep states. In existing solutions, all these actions are taken as binary decision(s). Such known approaches do not have the capability to roll back to a previous stable state in case of an incorrect decision.

Examples disclosed herein enable releasing of resources in a 5G/6G energy saving setup which uses AI/ML based prediction models for taking decisions, in a soft manner (e.g., a time-delayed manner), rather than a hard manner (e.g., an immediate change manner). This also enables rollback to a previous stable state, in the event of detection of an incorrect decision and/or a negative result (even, for example, if the decision was correct, by changing conditions made it less than ideal). Examples disclosed herein achieve this rollback capability by gradually releasing a part of one or more of the resource(s) (as compared to releasing the one or more of the resource(s) all at once) and continuously monitoring the performance and throughput KPIs of the network during this gradual release window and shortly thereafter. At any stage in this release process, if the performance and/or throughput monitored in the network drops below a threshold, the power-saving action is aborted, and a rollback process begins. In some examples, feedback may also be provided to the AI/ML model, to reduce future erroneous recommendations (e.g., to retrain the AI/ML model (e.g., by adjusting one or more of the model's hyperparameters) and/or by updating/fine-tuning the decision logic).

Examples disclosed herein are described in the context of cell on/off use cases. A cell on case is a situation in which an AI/ML model has identified that a cell is to be turned “on”. A cell off case is a situation in which an AI/ML model has identified that a cell is to be turned “off”. However, other use-cases may additionally or alternatively benefit from teachings of this disclosure. In some examples, a part of a resource can be quantized for various energy saving use-cases. In such examples, the part may refer to a portion of the amount of the service provided by the resource (e.g., a transmission power). For example, a part of a resource may refer to amount of Tx power to reduce in cell on/off use case, which intermediate array configuration to land in mMIMO antenna array cases, putting a fraction of a CPUs core (i.e., less than the entire core) into intermediate Cx/Pn states before entering a final sleep state, etc. The amount of resource to be released/pushed into sleep state can be calculated by considering different cell performance measures and QoS metrics of the user equipment (UE) as a function of the resource being released. For example, a signal to interference plus noise ratio (SINR) is directly dependent on the amount of transmit (Tx) power of the cell. If the Tx power is reduced, SINR will likewise be reduced.

Examples disclosed herein present adaptive power control circuitry which aims to reduce the impact of a major configuration change (e.g., cell on/off, antenna array change, Cx/Pn sleep states) and provisions for a roll-back to a stable state, in the event of an incorrect AI/ML predictions.

Given a variety of energy saving solutions available, and a variety of network deployments possible, a situation where some solutions are not applicable on a group of cells or a situation where all the solutions are applicable on a group of cells may arise. For example, a small cell may not be equipped with an mMIMO radio frequency (RF) antenna array and might only support complete cell on/off. In contrast, a capacity cell which has mMIMO antenna, enables provisioning for advanced sleep states and provisioning for cell on/off available, and thus supports step by step partial power downs.

Example adaptive power control circuitry disclosed herein may be implemented using many instances running, where one instance caters to a particular kind of energy saving approach (e.g., cell on/off, mMIMO RF configuration, advanced sleep states, CPU core on/off, etc.). Thus, in the event of an incorrect prediction (e.g., a prediction that is later proven to have a negative effect on QoS), examples disclosed herein ensure a minimal drop in QoS to the users. In this manner, a gradual adjustment of resources (gradual reduction of power, changing RF configuration in a step wise manner, etc.) while monitoring performance and throughput KPIs, and aborting the decision if there is a drop in QoS helps ensure a threshold QoS level for the end users.

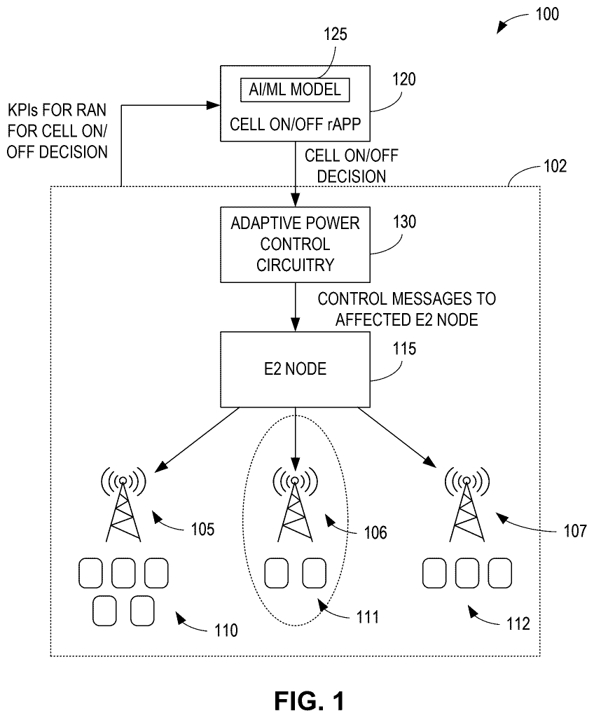

FIG. 1 is a block diagram of an example environment 100 in which an example adaptive power control circuitry 130 operates to provide adaptive roll-back of incorrect power savings decisions from AI/ML prediction models. The example environment 100 includes a radio area network (RAN) 102. The RAN 102 includes cells 105, 106, 107, which enable communication with user equipment 110, 111, 112. The cells 105, 106, 106 are controlled by an E2-node 115. The E2-node 115, in turn, is controlled by the adaptive power control circuitry 130. In the illustrated example of FIG. 1, the adaptive power control circuitry 130 receives instructions from a cell on/off rAPP 120. The rApp 120 generates such instructions based on execution of an AI/ML model 125. In this manner, the AI/ML model 125 may be used to generate recommendations for control of the RAN 102. However, as noted above, some of such recommendations, while perhaps being effective for saving power, might cause the RAN 102 to operate below a desired level of service, possibly violating a service level agreement (SLA).

The example cells 105, 106, 107 of FIG. 1 represent cellular base stations that communicate with the user equipment 110, 111, 112. In examples disclosed herein, the cells 105, 106, 107 communicate using wireless signaling protocols and/or standards, such as 5G and 6G signaling standards. However, any other communication protocols and/or standards may additionally or alternatively be used. For example, the cells 105, 106, 107 may be implemented as wireless access points that communicate using WiFi with the user equipment 110, 111, 112. In the illustrated example of FIG. 1, the user equipment 110, 111, 112 represent devices owned and/or operated by end users. In other words, the user equipment 110, 111, 112 represent the devices to which wireless communication services are ultimately provided. Service level agreements (SLAs) may be agreed upon between the mobile network operator and an operator of the user equipment 110, 111, 112. In this manner, it is important to provide a quality of service to the user equipment 110, 111, 112 that is commensurate with the SLA.

In the illustrated example of FIG. 1, the E2 node 115 provides the rAPP/xAPP (e.g., the adaptive power control circuitry 130) with key performance indicators (KPIs) and programs the cells 105, 106, 107 with configuration from xAPPs/rAPPs.

The rAPP 120 of FIG. 1 is implemented as a software application for non-real-time management of the RAN 102. Many different rAPPs might be utilized, depending on their purpose. In the illustrated example of FIG. 1, the rAPP 120 can be a single smart application which is able to pass down decisions and/or predictions to correct cells via the adaptive power control circuitry 130. In examples disclosed herein, the rAPP 120 is configured with a mobile network operator's (MNO's) preferences and/or priorities. The configuration states what energy saving capabilities are applicable to which cell and a priority in the order of applying such energy saving measures if multiple capabilities are present on a cell.

The decision made by the rAPP 120 (e.g., for any energy saving measures) can be made in many different ways. One common example is using an AI/ML algorithm which aims at maximizing the quality of service, maximizing resource utilization while using minimum energy, etc. Another approach can be by using an AI/ML algorithm to predict a future load based on observed cell key performance indicators (KPIs), physical resource block (PRB) usage, traffic, and topology. Based on the predicted load, the rAPP 120 makes a decision to start an energy saving operation, which is communicated to the adaptive power control circuitry 130.

For example, if a cell 105, 106, 107 is capable of multiple energy saving measures, then the rAPP 120 may trigger one operation at a time based on the priority set by the network operator. For example, a capacity cell in a downtown area may only undergo mMIMO antenna RF chain configuration during weekdays and during the daytime. In some examples, the cell on/off approach should only be applied on weekends and/or at nighttime.

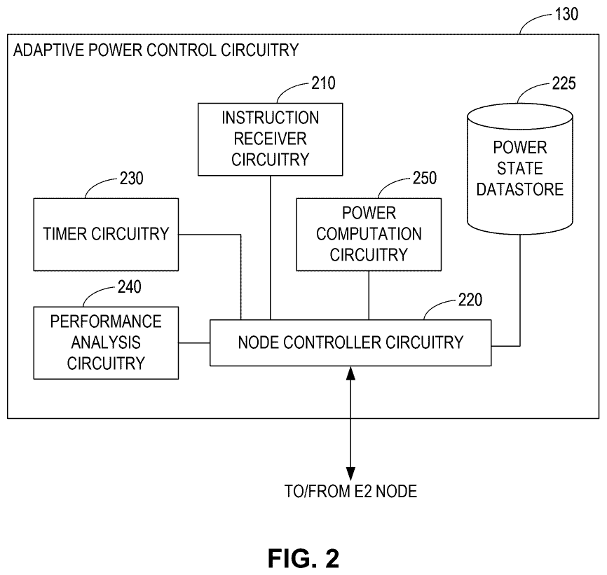

The example adaptive power control circuitry 130 of the illustrated example of FIG. 1 receives instructions from the rAPP 120 and determines whether to and/or how to implement such changes in the cells 105, 106, 107. An example implementation of the adaptive power control circuitry 130 is described in further detail in connection with FIG. 2. In examples disclosed herein, the adaptive power control circuitry 130 may be implemented using an xAPP. Such an xAPP may be configured with a mobile network operator's (MNO's) preferences and/or and priorities regarding energy saving functionalities. This configuration may be passed to the adaptive power control circuitry 130 from the rAPP 120 and/or may be stored separately at the adaptive power control circuitry 130. In some examples, a rollback configuration may be stored, stating the duration after which the adaptive power control circuitry 130 (e.g., an xAPP) should implement the rAPP's decision following an incorrect decision. In some examples, the duration can be as long as multiple hours for a more conservative deployment, and as short as five minutes, ten minutes, thirty minutes, etc. for certain use-cases. Such configuration information may additionally or alternatively include desired performance statistics of the user equipment including, for example, reference signal received power (RSRP), reference signal received quality (RSRQ), UE throughput, cell throughput, number of active UEs (e.g., per cell), etc.

The example adaptive power control circuitry 130 receives switch on and/or switch off decisions from the rAPP. In examples disclosed herein, these instructions are binary instructions (e.g., turn completely on, turn completely off). In some examples, the adaptive power control circuitry 130 calculates and communicates to the E2 node 115 how configuration information (e.g., transmission power) should be adjusted (e.g., increased, reduced). This instruction may be implemented over a series of messages transmitted from the adaptive power control circuitry 130 to the E2node 115.

For simplicity of explanation, examples disclosed herein are described in the context of a cell On/Off use-case as implemented on ORAN architecture using the adaptive power control circuitry 130 (e.g., an xAPP) and the rAPP 120. However, such approaches may also be useful when extended to other scenarios.

The adaptive power control circuitry 130 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the adaptive power control circuitry 130 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example adaptive power control circuitry 130 of the illustrated example of FIG. 2 includes instruction receiver circuitry 210, node controller circuitry 220, a power state datastore 225, timer circuitry 230, performance analysis circuitry 240, and power computation circuitry 250.

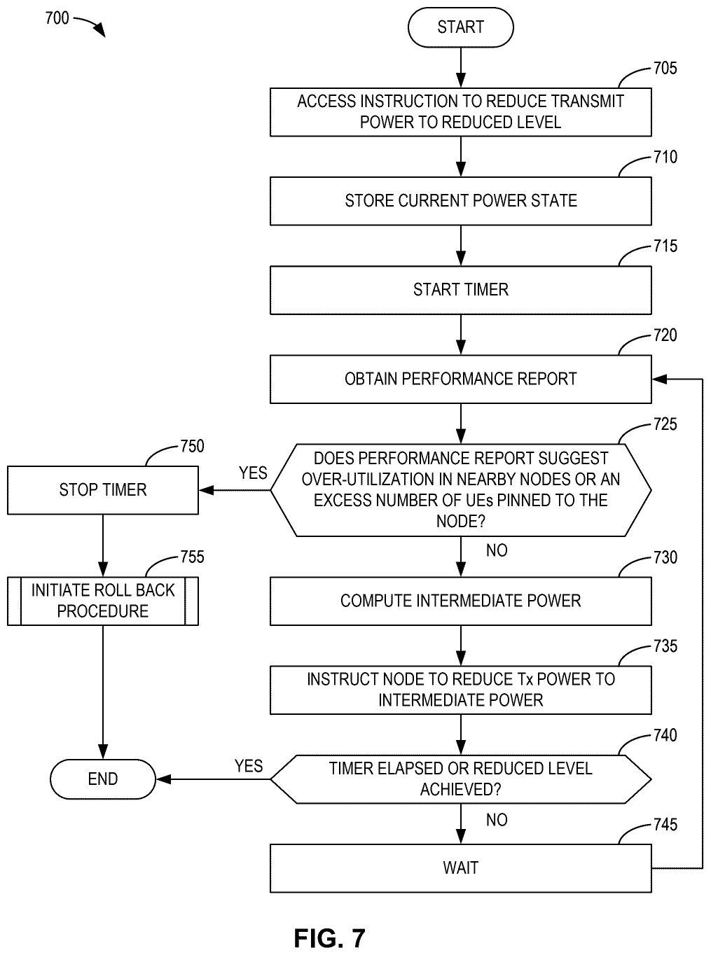

The example instruction receiver circuitry 210 of the illustrated example of FIG. 2 accesses one or more instructions from the rAPP 120 to transition to a desired power level. In some examples, the instruction(s) may direct the adaptive power control circuitry 130 to transition a cell to an “on” state, an “off” state, or any intermediate power state in-between. While examples disclosed herein are described in the context of a mobile network, such examples are also applicable to other values that are instructed at the direction of an artificial intelligence or machine learning model. In some examples, the instruction receiver circuitry 210 is instantiated by programmable circuitry executing instruction receipt instructions and/or configured to perform operations such as those represented by the flowchart(s) of FIGS. 7 and/or 8.

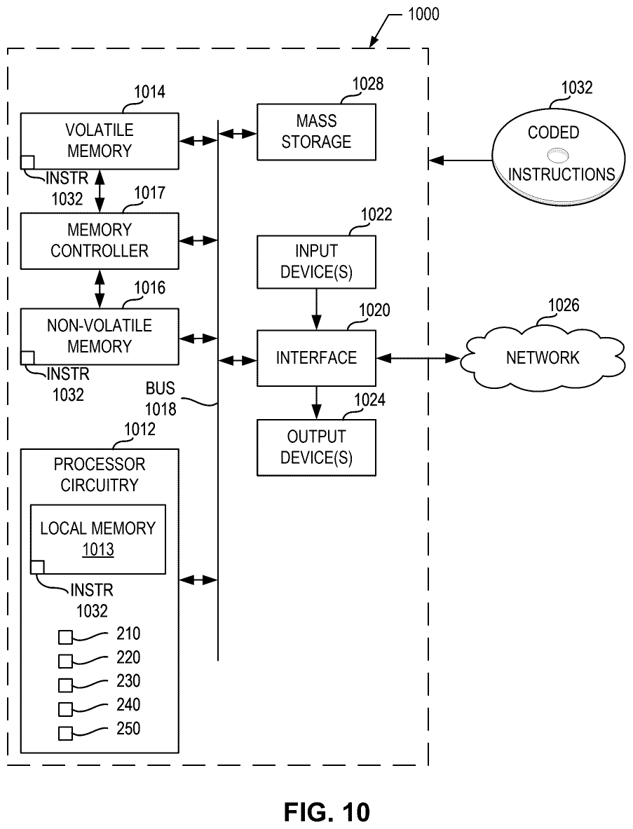

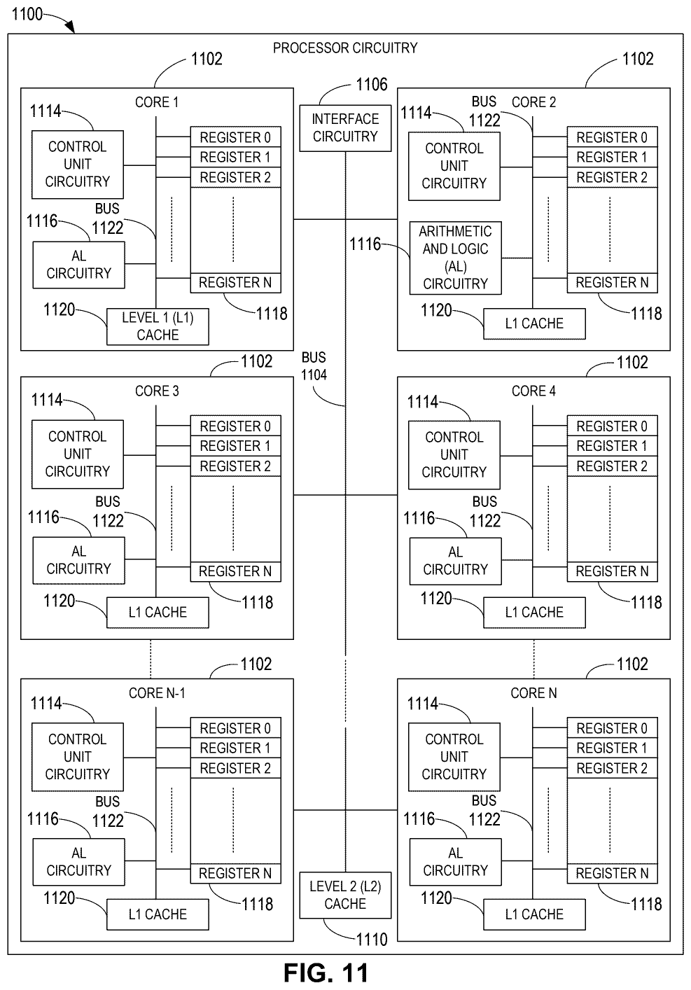

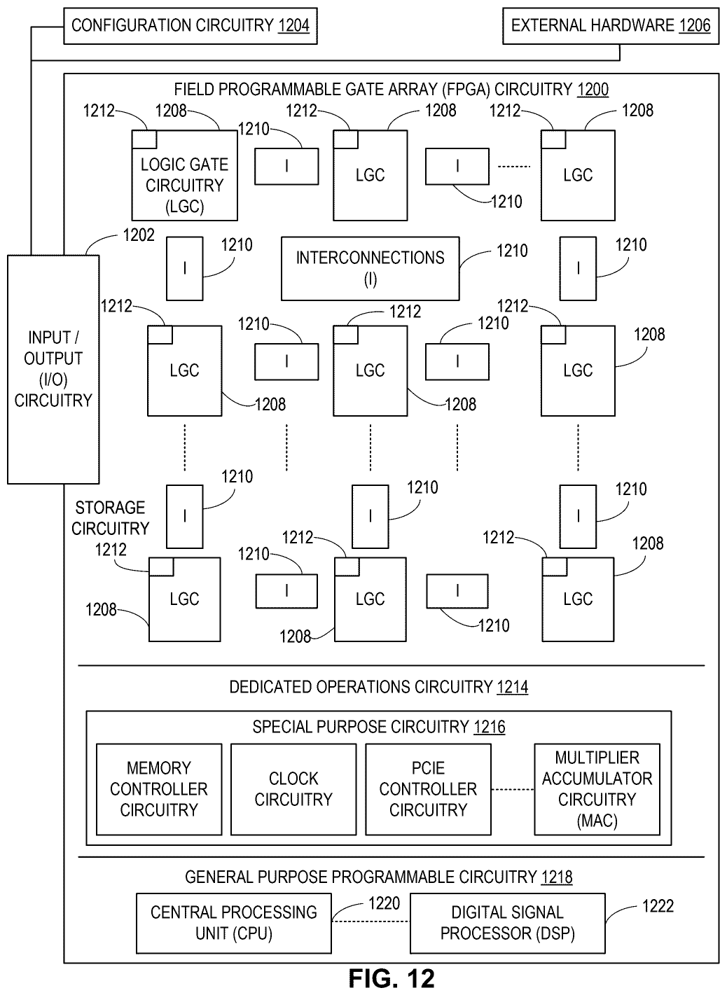

In some examples, the adaptive power control circuitry 130 includes means for identifying a cell. For example, the means for identifying may be implemented by instruction receiver circuitry 210. In some examples, the instruction receiver circuitry 210 may be instantiated by programmable circuitry such as the example programmable circuitry 1012 of FIG. 10. For instance, the instruction receiver circuitry 210 may be instantiated by the example microprocessor 1100 of FIG. 11 executing machine executable instructions such as those implemented by at least blocks 705, 805 of FIGS. 7 and/or 8. In some examples, the instruction receiver circuitry 210 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the instruction receiver circuitry 210 may be instantiated by any other combination of hardware, software, and/or firmware. For example, the instruction receiver circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

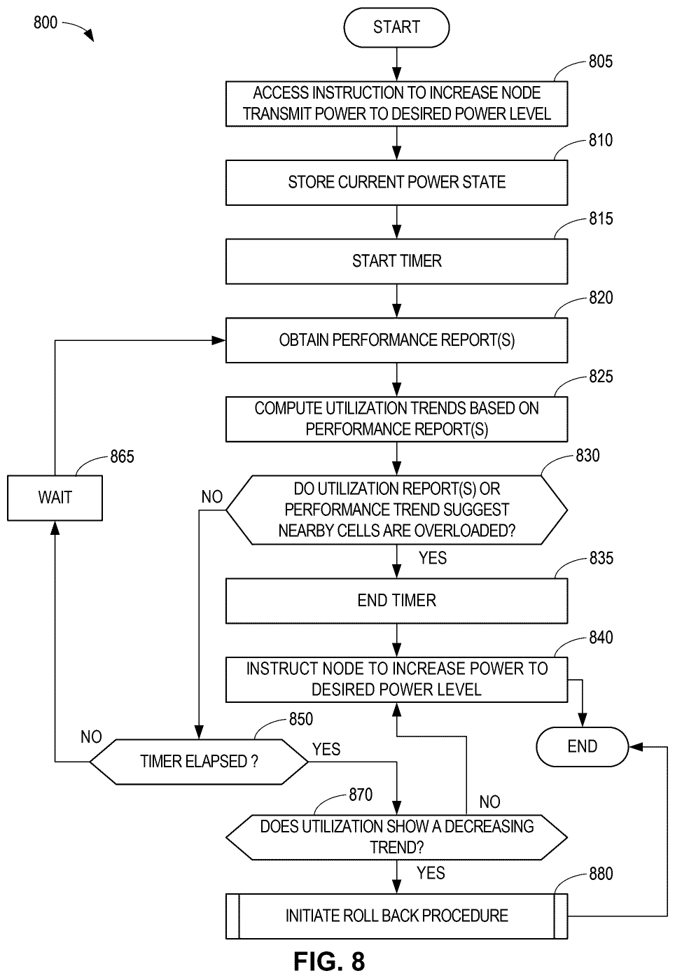

The example node controller circuitry 220 of the illustrated example of FIG. 2 obtains performance reports from the E2 node 115 and provides instructions to the E2 node. The node controller circuitry 220 causes storage of existing states into the power state datastore 225, enabling the node controller circuitry 220 to, if necessary, instruct the E2 node 115 to roll back to a previous state. In some examples, the node controller circuitry 220 provides one or more alerts to an operator of a mobile network in the event of a rollback to a previous state. Such information is useful because it represents a situation where a prediction and/or inference made by the AI/ML model 125 caused or would have caused a degradation in a quality of service (or possibly a violation of an SLA). Accordingly, such information may be useful in triggering re-training of the AI/ML model 125. In some examples, the node controller circuitry 220 is instantiated by programmable circuitry executing node controller instructions and/or configured to perform operations such as those represented by the flowchart(s) of FIGS. 7, 8, and/or 9.

In some examples, the adaptive power control circuitry 130 includes means for instructing. For example, the means for instructing may be implemented by node controller circuitry 220. In some examples, the node controller circuitry 220 may be instantiated by programmable circuitry such as the example programmable circuitry 1012 of FIG. 10. For instance, the node controller circuitry 220 may be instantiated by the example microprocessor 1100 of FIG. 11 executing machine executable instructions such as those implemented by at least blocks 710, 720, 735, 740, 745, 755, 810, 820, 835, 840, 865, 880, 910, 920 of FIGS. 7, 8, and/or 9. In some examples, the node controller circuitry 220 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the node controller circuitry 220 may be instantiated by any other combination of hardware, software, and/or firmware. For example, the node controller circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example power state datastore 225 of the illustrated example of FIG. 2 is implemented by any memory, storage device and/or storage disc for storing data such as, for example, flash memory, magnetic media, optical media, solid state memory, hard drive(s), thumb drive(s), etc. Furthermore, the data stored in the example power state datastore 225 may be in any data format such as, for example, binary data, comma delimited data, tab delimited data, structured query language (SQL) structures, etc. While, in the illustrated example, the power state datastore 225 is illustrated as a single device, the example power state datastore 225 and/or any other data storage devices described herein may be implemented by any number and/or type(s) of memories. In the illustrated example of FIG. 2, the example power state datastore 225 stores power state information. Such power state information may be formatted as a vector which stores the current configuration of the cell related to power, antenna array configuration, neighbor offsets, etc.

In some examples, the adaptive power control circuitry 130 includes means for storing, which may be implemented by the example power state datastore 225.

The example timer circuitry 230 of the illustrated example of FIG. 2 operates a timer used to control an amount of time that is to be taken to transition from a current state to a desired state. In this manner, the timer may be thought of as a count-down timer, in that the timer is set to an initial amount of time which counts down to zero, representing that the timer has elapsed. However, in some examples, other timing techniques may additionally or alternatively be used. In some examples, the timer circuitry 230 is instantiated by programmable circuitry executing timing instructions and/or configured to perform operations such as those represented by the flowchart(s) of FIGS. 7 and/or 8.

In some examples, the adaptive power control circuitry 130 includes means for timing. For example, the means for timing may be implemented by timer circuitry 230. In some examples, the timer circuitry 230 may be instantiated by programmable circuitry such as the example programmable circuitry 1012 of FIG. 10. For instance, the timer circuitry 230 may be instantiated by the example microprocessor 1100 of FIG. 11 executing machine executable instructions such as those implemented by at least blocks 715, 750, 815, 835, 850 of FIGS. 7 and/or 8. In some examples, the timer circuitry 230 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the timer circuitry 230 may be instantiated by any other combination of hardware, software, and/or firmware. For example, the timer circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example performance analysis circuitry 240 of the illustrated example of FIG. 2 collects and/or analyzes performance report(s) to determine whether transitioning from one state to another is appropriate. For example, the performance analysis circuitry 240 may determine whether there is an over-utilization in nearby nodes, or an excess number of UEs that are pinned to the affected node, in order to determine whether it is appropriate to transition a node to a lower power state (e.g., an “off” state). In some examples, the performance analysis circuitry 240 is instantiated by programmable circuitry executing performance analysis instructions and/or configured to perform operations such as those represented by the flowchart(s) of FIGS. 7 and/or 8.

In some examples, the adaptive power control circuitry 130 includes means for analyzing. For example, the means for analyzing may be implemented by performance analysis circuitry 240. In some examples, the performance analysis circuitry 240 may be instantiated by programmable circuitry such as the example programmable circuitry 1012 of FIG. 10. For instance, the performance analysis circuitry 240 may be instantiated by the example microprocessor 1100 of FIG. 11 executing machine executable instructions such as those implemented by at least blocks 725, 825 of FIGS. 7 and/or 8. In some examples, the performance analysis circuitry 240 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the performance analysis circuitry 240 may be instantiated by any other combination of hardware, software, and/or firmware. For example, the performance analysis circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

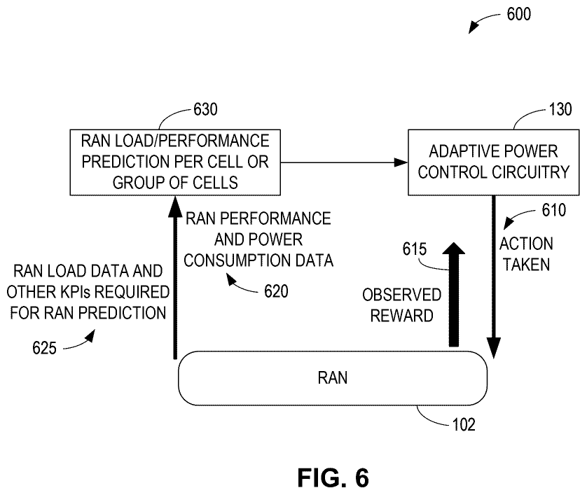

The example power computation circuitry 250 of the illustrated example of FIG. 2 calculates an amount of transmission power to instruct the E2 node to transition a cell, based on the current performance report(s). In some examples, this transmission power is an intermediate transmission power (e.g., a power level that is intermediate the current or initial power level and the desired power level). The amount of power to be reduced (or increased) may be computed in multiple different ways. For example, a reinforcement learning approach may be utilized to select the amount of power to be reduced, a deterministic formula may be used, a minimum transmission power calculation may be used, etc. Example approaches to computing power levels are disclosed in further detail in connection with FIG. 6. In some examples, the power computation circuitry 250 is instantiated by programmable circuitry executing power computation instructions and/or configured to perform operations such as those represented by the flowchart(s) of FIG. 7.

In some examples, the adaptive power control circuitry 130 includes means for computing. For example, the means for computing may be implemented by power computation circuitry 250. In some examples, the power computation circuitry 250 may be instantiated by programmable circuitry such as the example programmable circuitry 1012 of FIG. 10. For instance, the power computation circuitry 250 may be instantiated by the example microprocessor 1100 of FIG. 11 executing machine executable instructions such as those implemented by at least blocks 730 of FIG. 7. In some examples, the power computation circuitry 250 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the power computation circuitry 250 may be instantiated by any other combination of hardware, software, and/or firmware. For example, the power computation circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the adaptive power control circuitry 130 of FIG. 1 is illustrated in FIG. 2, one or more of the elements, processes, and/or devices illustrated in FIG. 2 may be combined, divided, re-arranged, omitted, eliminated, and/or implemented in any other way. Further, the instruction receiver circuitry 210, node controller circuitry 220, timer circuitry 230, performance analysis circuitry 240, power computation circuitry 250, and/or, more generally, the example adaptive power control circuitry 130 of FIG. 2, may be implemented by hardware alone or by hardware in combination with software and/or firmware. Thus, for example, any of the instruction receiver circuitry 210, node controller circuitry 220, timer circuitry 230, performance analysis circuitry 240, power computation circuitry 250, and/or, more generally, the example adaptive power control circuitry 130, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example adaptive power control circuitry 130 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the adaptive power control circuitry 130 of FIG. 2 and/or representative of example operations which may be performed by programmable circuitry to implement and/or instantiate the adaptive power control circuitry 130 of FIG. 2, are shown in FIGS. 7, 8, and/or 9. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7, 8, and/or 9, many other methods of implementing the example adaptive power control circuitry 130 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 7, 8, and/or 9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

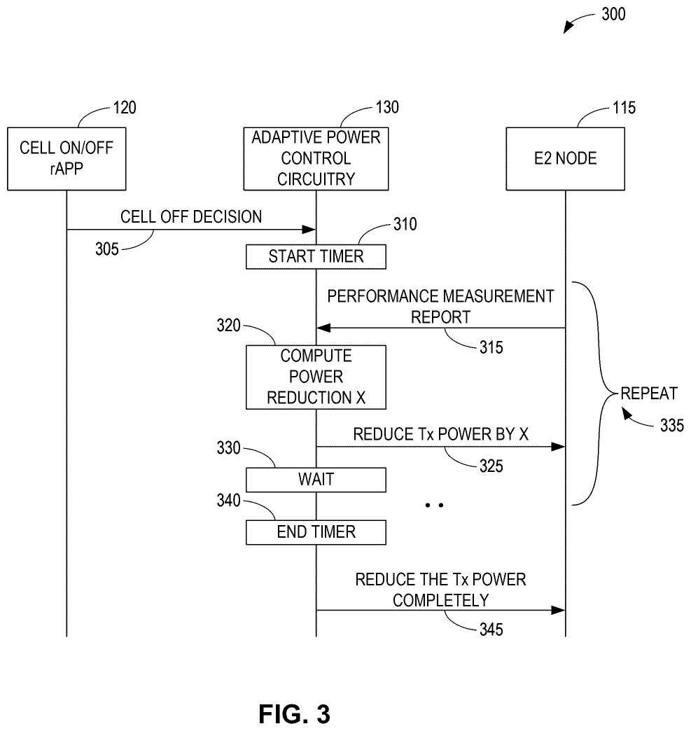

FIG. 3 is a sequence diagram illustrating an example flow of events for a cell off event. At arrow 305 of FIG. 3, the Cell On/Off rAPP 120 communicates a decision to switch off a Cell. At block 310 of FIG. 3, on receipt of the “cell switch off” message, the adaptive power control circuitry 130 determines if there are sufficient alternate cells/coverage available to the cells of impacted UEs and if the cell can be switched off. For example, the adaptive power control circuitry 130 uses information about its immediate neighbors, their resource utilization, etc. The adaptive power control circuitry 130 may also prepare an estimate (which can be configured) about the maximum resource utilization of the neighbors. Based on these metrics, the adaptive power control circuitry 130 checks if neighbors have sufficient resources to handle movement of UEs from affected cell to them. If not, decision of switch-off is ignored.

If the cell can be practically switched off, then the adaptive power control circuitry 130 starts a “Cell Switch Off” Timer. (Block 310). At the end of this timer, the cell could be switched off completely. While this timer runs, the adaptive power control circuitry 130 will monitor the UE/Cell measurements from the e2 node 115 and gradually reduce power, monitoring for error conditions along the way.

At arrow 315 of FIG. 3, the adaptive power control circuitry 130 obtains a performance measurement report from the E2 node 115. At block 320, the adaptive power control circuitry 130 calculates the amount of transmission power to reduce based on the current performance reports and signals this to E2 node. (Arrow 325). A few approaches are suggested below on how to determine the amount of Tx power to be reduced. The E2 node 115 reduces the transmission power of the cell by the amount signaled, and the process waits. (Block 330). The process of arrow 315 through block 330 is repeated 335 until the timer expires (Block 340) or an error condition is detected. As the transmission power is reduced, the e2 node 115 might observe some handovers and/or performance reports from the still pinned UEs, which could show a decrease in signal strength of the serving cell and decrease in performance values of the UEs.

In some examples, if the adaptive power control circuitry 130 decides that the cell off operation is not feasible, the adaptive power control circuitry 130 may over-rules the cell off decision. For example, if the adaptive power control circuitry 130 finds that the Tx power reduction is causing over-utilization of resources in neighbors or UEs still pinned to the affected cell (e.g., the cell being switched off), the adaptive power control circuitry 130 may conclude that an incorrect decision has been made. Cell Switch-off timer is stopped and a roll-back process may be initiated (described below).

If the timer expires without an interrupt (block 340), the adaptive power control circuitry 130 instructs the e2 node 115 to reduce the transmission power to zero and cell is switched off.

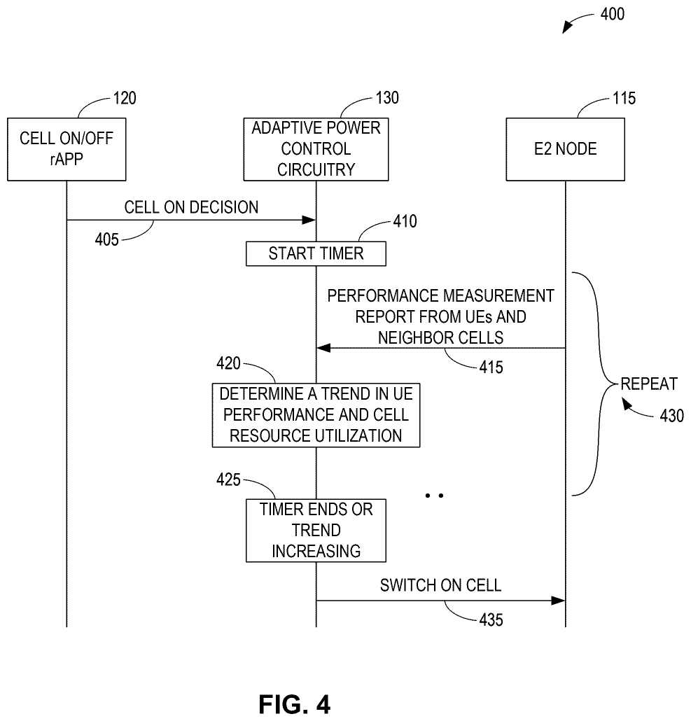

FIG. 4 is a sequence diagram illustrating an example flow of events for a cell on event. Thus, while very similar to the sequence of FIG. 3, in the illustrated example of FIG. 4, the example adaptive power control circuitry 130 monitors for conditions that suggest that the actual load on the network is not as high as had been anticipated (e.g., conditions do not merit a “turn on” instruction).

At arrow 405, the Cell On/Off rAPP 120 communicates a decision to switch on a cell. On receipt of the “cell switch on” message, the adaptive power control circuitry 130 stores the cell's current state, and starts a “cell switch ON” timer. (Block 410). At the end of this timer, the cell would be running with full capacity (e.g., in a fully “on” state). The adaptive power control circuitry 130 obtains a periodic measurement report from the E2 node 115 identifying UEs and neighbor cells to the adaptive power control circuitry 130. In some examples, these reports are UE RSRP reports, PRB usage, resource utilization, etc. The example adaptive power control circuitry 130 monitors the measurement reports, PRB usage, resource utilization of the neighbor cells and UEs and identifies one or more trends in these measurements. (Block 420). If the reports and/or trends show that the neighbor cell(s) are already over-utilized, the cell may be immediately switched-on by breaking the loop.

At block 425, at the end of the cell switch ON timer, if there is an increasing trend in PRB usage, resource utilization, etc the cell is switched ON. (Arrow 435). If there is a definite decreasing trend, the adaptive power control circuitry 130 chooses not to switch ON the cell, and starts the rollback process. However, this implementation can be made in agreement with the MNO beforehand. The MNO may choose to always acknowledge the cell switch ON message (e.g., to be more conservative).

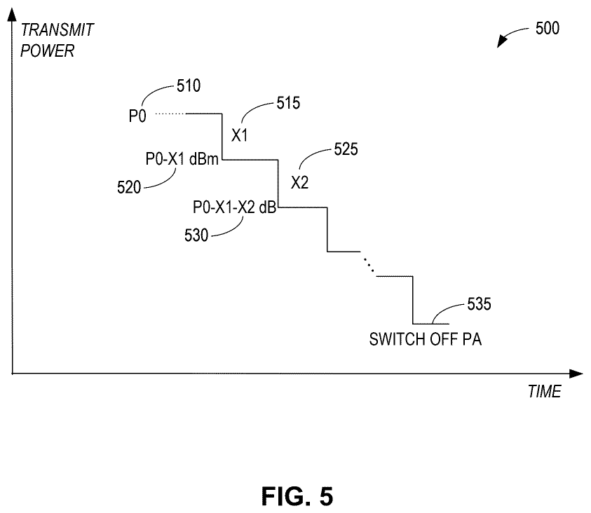

FIG. 5 is a graph 500 illustrating power states over time in response to an instruction to reduce transmission power. An x axis of the graph 500 represents time, while the y axis of the graph 500 represents transmission power. At an initial time, the power state is at P0 510. A first reduction in power (X1 515) is identified by the adaptive power control circuitry 130, and the transmission power is transitioned to a second power state P0-X1 520. Later, a second reduction in power (X2 525) is identified by the adaptive power control circuitry 130, and the transmission power is transitioned to a third power state P0-X1-X2 530. The reductions in power need not be equal. In other words, X1 515 need not be equal to X2 525. This process repeats until a final power state (e.g., an off state) 535 is achieved.

The amount of power to be reduced (or increased) may be computed in multiple different ways. For example, a reinforcement learning approach may be utilized to select the amount of power to be reduced, a deterministic formula may be used, a minimum transmission power calculation may be used, etc.

FIG. 6 is a diagram illustrating an example reinforcement learning (RL) approach 600 to computing an amount of power to be reduced. In the illustrated example of FIG. 6, an action to be taken 610 is identified by the adaptive power control circuitry 130 and is provided to the RAN 102. In some examples, the action corresponds to a reduction in transmission power by a quantum level {L1,L2, . . . Ln,B}. Such a quantum level may include an option B, which corresponds to backtracking the cell on/off decision and not switching the off cell. The action may be determined based on RAN performance and power consumption data 620, RAN load data and/or other KPIs 625, and RAN load and performance predictions per cell or group(s) of cells 630. A reward 615 may be computed that corresponds to a function of performance and power consumption, for example:

$$R = f ( Cell\_throughput ) - K \cdot g ( overhead ) \qquad Equation 1$$

Where K is the weighting factor for the overhead determined by the mobile network operator's preferences, f(Cell throughput/UE_throughput) is a measure of performance, and g(overhead) is a measure of power consumption. In some examples, Q learning may be utilized to learn the long-term reward Q(S,A) and chose an appropriate action 610 to maximize the Q function.

While a reinforcement learning approach to reducing transmission power is described above, a similar RL agent could be designed for reducing a number of mMIMO antennas utilized, CPU cores utilized, etc. to make the process of switching off a soft-switch-off rather than hard-switch-off decision.

In addition to reinforcement learning techniques, other approaches for computing an amount of power to be reduced may additionally or alternatively be used. For example, the relation between Tx Power and performance measure can be determined by a deterministic formula, or a more sophisticated AI Model. An example approach to reduce power can be to: (1) Find the median performance value in a list of received measurement reports, (2) calculate a power which corresponds to the median performance value, and (3) set an amount of Tx-power to reduce the difference between current Tx power and power obtained in step (2). This approach keeps on reducing the Tx power by some amount until the cell switch off timer expires, after which the adaptive power control circuitry 130 can completely switch off the cell.

Additionally or alternatively, an approach to calculate the amount of Tx power to be reduced may be utilized. For example, the adaptive power control circuitry 130 may calculate the minimum transmission power (Pmin) for serving all the active UEs in the cell such that the resource utilization of the cell is maximized (or with a margin, 10%). In such an example, it is assumed that the adaptive power control circuitry 130 can access a link quality (CQI) and traffic load of all the active UEs in the cell. The adaptive power control circuitry 130 may use Pnow to indicate a current Tx power, and then reduces the Tx power by Pnow−Pmin.

FIG. 7 is a flowchart representative of example machine readable instructions and/or example operations 700 that may be executed, instantiated, and/or performed by programmable circuitry to gradually decrease transmission power. The example machine-readable instructions and/or the example operations 700 of FIG. 7 begin at block 705, at which the instruction receiver circuitry 210 accesses an instruction to reduce transmit power to a reduced level. (Block 705). In examples disclosed herein the instruction is received from the cell on/off rAPP 120 and is based on a prediction made by the AI/ML model 125. The instruction identifies one or more cells (e.g., cell 105, 106, 107) that are to be adjusted to a decreased power state (e.g., to a lower transmission power level, to an OFF state, etc.). The node controller circuitry 220 obtains a current power state of the identified cells. (Block 710) The node controller circuitry 220 stores this information in the power state datastore 225.

The example timer circuitry 230 begins a timer. (Block 715). The timer is set to a finite time period before expiring. For example, the timer may be set to ten minutes, thirty minutes, one hour, two hours, etc. While this timer runs, the adaptive power control circuitry 130 will monitor the UE/Cell measurements from the e2 node 115 and gradually reduce power, monitoring for error conditions along the way. The example node controller circuitry 220 obtains a performance report from the E2 node 115. (Block 720). The example performance analysis circuitry 240 analyzes the performance report to determine whether there is an over-utilization in nearby nodes, or an excess number of UEs that are pinned to the affected node. (Block 725). If nearby cells/nodes are already over-loaded, reducing transmission power will force UEs communicating with the affected node/cell to begin communicating with the already over-loaded cell/node, likely resulting in a degradation of quality of service. When a UE is pinned to a node or cell, the UE does not have any alternate node or cell with which it may communicate. Thus, turning off a particular cell will result in total loss of service for the pinned UE. If, at block 725 the performance analysis circuitry 240 determines that nearby nodes are over-utilized or there are an excess number of UEs pinned to an affected node, the timer circuitry 750 stops the timer (block 750), and the node controller circuitry 220 initiates a roll-back procedure. (Block 755).

Returning to block 725, if the performance report does not suggest over-utilization or an excess number of UEs pinned to the affected node, the example power computation circuitry 250 calculates the amount of transmission power to reduce based on the current performance report(s). (Block 730). In some examples, this reduced transmission power is an intermediate transmission power (e.g., a power level that is intermediate the current or initial power level and the desired power level). As the process 700 of FIG. 7 progresses, any number of intermediate power levels may be identified until the desired power level is reached, the timer elapses, an error condition is detected that causes the rollback procedure to be executed, etc.

The node controller circuitry 220 instructs the E2 node 115 to reduce the transmission power of the cell by the calculated amount. (Block 735). The node controller circuitry 220 determines whether the time has elapsed or the reduced level (e.g., the desired level) has been achieved. If the timer has not yet elapsed or the reduced power level has not yet been achieved, the node controller circuitry 220 waits an amount of time (block 745) before the process returns to block 720 and repeats. The process 700 of FIG. 7 then repeats until the timer expires, the reduced power level is achieved, or an error condition is detected. As the transmission power is reduced, the e2 node 115 might observe some handovers and/or performance reports from the still pinned UEs, which could show a decrease in signal strength of the serving cell and decrease in performance values of the UEs.

In some examples, if the desired power level is an “off” state and the transmission power has reached as low of a level as is possible, the adaptive power control circuitry 130 may additionally instruct the e2 node 115 to completely turn the affected cell off.

In some examples, prior to acting upon the instruction to turn off a cell (e.g., to reduce power), the adaptive power control circuitry 130 determines if there are sufficient alternate cells/coverage available to the cells of impacted UEs and if the cell can be switched off. For example, the adaptive power control circuitry 130 uses information about the immediate neighbors of the cell, their resource utilization, etc. The adaptive power control circuitry 130 may also prepare an estimate (which can be configured) about the maximum resource utilization of the neighbors. Based on these metrics, the adaptive power control circuitry 130 checks if neighbors have sufficient resources to handle movement of UEs from affected cell to them. If not, decision of switch-off is ignored.

FIG. 8 is a flowchart representative of example machine readable instructions and/or example operations 800 that may be executed, instantiated, and/or performed by programmable circuitry to increase transmission power to a desired level (e.g., an “on” state). The example machine-readable instructions and/or the example operations 800 of FIG. 8 begin at block 805, at which the instruction receiver circuitry 210 accesses an instruction to increase transmit power to a desired level. (Block 805). In examples disclosed herein, the instruction is received from the cell on/off rAPP 120 and is based on a prediction made by the AI/ML model 125. The instruction identifies one or more cells (e.g., cell 105, 106, 107) that are to be adjusted to an increased power state (e.g., to an increased transmission power level, to an ON state, etc.). The node controller circuitry 220 obtains a current power state of the identified cells. (Block 810) The node controller circuitry 220 stores this information in the power state datastore 225.

In contrast to FIG. 7, where power states are gradually decreased, in FIG. 8, the adaptive power control circuitry 130 monitors conditions before instructing the node to increase directly to the desired power level. If, for example, power levels were gradually increased, a UE might attach to a cell with a relatively low signal strength, reducing the quality of service for the UE.

The example timer circuitry 230 begins a timer. (Block 815). The timer is set to a finite time period before expiring. For example, the timer may be set to ten minutes, thirty minutes, one hour, two hours, etc. While this timer runs, the adaptive power control circuitry 130 will monitor the UE/Cell measurements from the e2 node 115 and confirm that the conditions still support increasing to a desired power level, monitoring for error conditions along the way. The example node controller circuitry 220 obtains a performance report from the E2 node 115. (Block 820). The example performance analysis circuitry 240 analyzes the performance report to compute utilization trends. (Block 825). The performance analysis circuitry 240 determines whether the utilization report(s) and/or the utilization trends suggest that nearby cells are overloaded. (Block 830). If nearby cells/nodes are already over-loaded, increasing transmission power (e.g., turning a cell “on”) will improve quality of service for those UEs that are communicating with overloaded cells.

If utilization reports and/or trends suggest that the nearby cells are overloaded (e.g., block 830 returns a result of YES), the timer circuitry 230 stops the timer (block 835) and the node controller circuitry 220 instructs the node to increase power to the desired power level. (Block 840).

If utilization reports and/or trends do not suggest that the nearby cells are overloaded (e.g., block 830 returns a result of NO), the example node controller circuitry 220 determines whether the timer has elapsed. (Block 850). If the end of the timer has not been reached, the example node controller circuitry 220 waits (Block 865), and control returns to block 820.

If the end of the timer (e.g., a waiting period) has been reached, the node controller circuitry 220 determines whether a decreasing utilization trend of nearby nodes has been identified. (Block 870). If a decreasing utilization trend is identified, this suggests that the requested increase is no longer warranted. In such a situation, a rollback procedure may be initiated. (Block 880).

If a decreasing trend is not identified (e.g., block 870 returns a result of NO), control proceeds to block 840 where the node controller circuitry 220 instructs the node to increase the power to the desired power level. (Block 840).

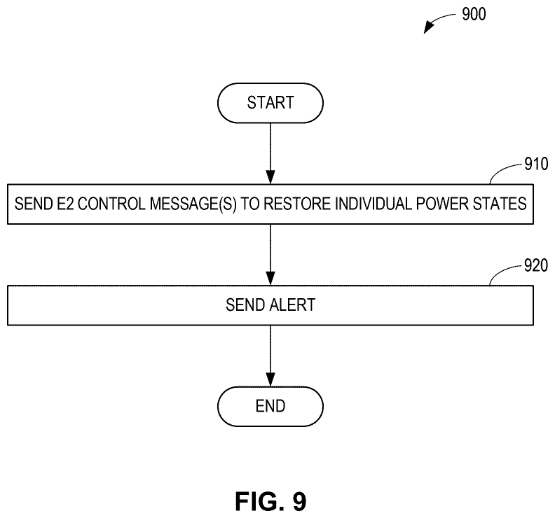

FIG. 9 is a flowchart representative of example machine readable instructions and/or example operations 900 that may be executed, instantiated, and/or performed by programmable circuitry to cause the adaptive power control circuitry to perform a rollback procedure. The example machine-readable instructions and/or the example operations 900 of FIG. 9 begin at block 910, at which the node controller circuitry 220 sends one or more control messages to the E2 node 115 to restore individual power states. (Block 910). In examples disclosed herein, the individual power states are retrieved from the power state datastore 225.

As noted above, a rollback process is triggered when the example adaptive power control circuitry 130 concludes that the decision to perform a power saving action is incorrect. This can be because of, for example, observed throughput drops in UEs, overloading of neighbor cells, etc. To accomplish this, the example node controller circuitry 220 transmits E2 control messages to restore individual states related to transmit power, neighbor offset, array configuration, etc. In the illustrated example of FIG. 9, the node controller circuitry 220 sends an alert, to enable an operator to take account of this inaccuracy. (Block 920). In some examples, the alert may be in the form of a log entry, an alert on a dashboard, or any other type of message or indication that a prior state had been restored. This can be in the form of logs or an alert on a dashboard. As a part of this alert, the adaptive power control circuitry 130 may also capture UE state(s), numbers, PRB usage, etc. for further analysis and/or inclusion in the alert. In some examples, this alert is used as a cue for retraining the model (e.g., the model 125) that was used to initiate the incorrect decision. In some examples, the adaptive power control circuitry 130 uses the alert to consider whether further instructions from the rAPP 120 should be delayed before implementation or subsequent calculations of changes to power states should be reduced (e.g., to allow a longer period of time to elapse for full implementation of a requested change). Delaying or slowing implementation of a recommended change enables the adaptive power control circuitry 130 to consider whether a SLA degradation already happening or about to happen.

FIG. 10 is a block diagram of an example programmable circuitry platform 1000 structured to execute and/or instantiate the example machine-readable instructions and/or the example operations of FIGS. 7, 8, and/or 9 to implement the adaptive power control circuitry 130 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, VPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example instruction receiver circuitry 210, the example node controller circuitry 220, timer circuitry 230, the example performance analysis circuitry 240, and the example power computation circuitry 250.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 7, 8, and/or 9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 7, 8, and/or 9 to effectively instantiate the circuitry of FIG. 2 as logic circuits to perform operations corresponding to those machine readable instructions. In some such examples, the circuitry of FIG. 2 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7, 8, and/or 9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 7, 8, and/or 9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7, 8, and/or 9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7, 8, and/or 9. As such, the FPGA circuitry 1200 may be configured and/or structured to effectively instantiate some or all of the operations/functions corresponding to the machine readable instructions of the flowchart(s) of FIGS. 7, 8, and/or 9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 7, 8, and/or 9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 7, 8, and/or 9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 7, 8, and/or 9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 7, 8, and/or 9, and/or an ASIC may be configured and/or structured to perform third operation(s)/function(s) corresponding to a third portion of the machine readable instructions represented by the flowcharts of FIGS. 7, 8, and/or 9.

It should be understood that some or all of the circuitry of FIG. 2 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 2 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

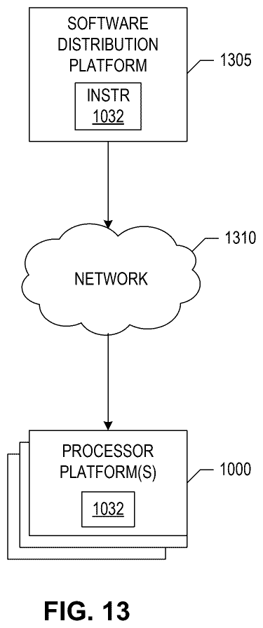

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 7, 8, and/or 9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIGS. 7, 8, and/or 9, may be downloaded to the example programmable circuitry platform 1000, which is to execute the machine readable instructions 1032 to implement the adaptive power control circuitry 130. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable gradual transitions between power states and facilitate rollbacks when monitored network conditions indicate reversal is appropriate. Disclosed systems, apparatus, articles of manufacture, and methods improve the efficiency of using a computing device by ensuring that incorrect predictions made by AI/ML systems can be detected in near real time and changes revert to prevent degraded quality of service conditions in communications systems. The gradual releasing of resources approach works efficiently because a gradual releasing of resources (e.g., a decrement in power) would trigger handover of the UEs to one or more other cells, which enables monitoring and detection of QoS issues. This gradual procedure ensures reduced (e.g., minimal) impact on QoS. Because of the gradual releasing and continuous monitoring of resources, examples disclosed herein also have the ability to rollback to a previous state if an unexpected degradation of service is encountered. Some such examples also help save resources when a “switch on” decision is communicated. A switch on decision doesn't hamper the SLA or QoS, but such a decision may sometimes lead to inefficient usage of resources. Disclosed examples also provide ways to check the inaccuracies in “switch on” cases. Disclosed systems, apparatus, articles of manufacture, and methods are accordingly directed to one or more improvement(s) in the operation of a machine such as a computer, a communications network control system, a cellular basestation, or other electronic and/or mechanical device.

Moreover, examples disclosed herein incorporate a network operators preferences into this decision making, such as when to perform a rollback, how quickly a gradual release or resources should occur, etc. Such incorporation adds a layer of flexibility and surety. During rollback procedures, operators are provided with real feedback to update the cell on/off decision logic and possibly retrain the AI/ML model. The suggested approach instills a layer of confidence in such delicate operations, enhancing user acceptance of such systems.

Example methods, apparatus, systems, and articles of manufacture to methods and apparatus for adaptive roll-back of incorrect power saving decisions from AI/ML prediction models are disclosed herein. Further examples and combinations thereof include the following:

Example 1 includes at least one non-transitory computer readable medium comprising instructions to cause at least one programmable circuit to at least identify a cell to be transitioned to a reduced power state, the identification of the cell based on a message from a radio access network intelligent controller application (rAPP), cause storage of information representing an initial power state of the cell, compute an intermediate power state for the cell, the intermediate power state intermediate a current power state of the cell and the reduced power state of the cell, cause a node to transition the cell to the intermediate power state, analyze a performance report from the node to detect a degradation in quality of service, and in response to the detection of the degradation in the quality of service, cause the cell to revert to the initial power state.

Example 2 includes the at least one non-transitory computer readable medium of example 1, wherein the message from the rAPP is based upon an inference from a machine learning model.

Example 3 includes the apparatus of any one or more of examples 1-2, wherein the instructions are to cause one or more of the at least one programmable circuit to trigger an alert to an operator of a communications network in response to the detection of the degradation in the quality of service.

Example 4 includes the at least one non-transitory computer readable medium of example 3, wherein the message from the rAPP is based upon an inference from a machine learning model and the alert is to cause re-training of the machine learning model.

Example 5 includes the at least one non-transitory computer readable medium of any one of examples 1-4, wherein the instructions are to cause one or more of the at least one programmable circuit to determine the intermediate power state using reinforcement learning.

Example 6 includes the at least one non-transitory computer readable medium of any one of examples 1-5, wherein the instructions are to cause one or more of the at least one programmable circuit to initiate a timer after receipt of the message, and cause the node to transition the cell to the reduced power state upon elapse of the timer.

Example 7 includes the at least one non-transitory computer readable medium of example 6, wherein one or more of the at least one programmable circuit is to monitor the performance report to detect the degradation in the quality of service prior to elapse of the timer.

Example 8 includes an apparatus comprising interface circuitry, machine-readable instructions, and at least one programmable circuitry to be programmed by the machine readable instructions to identify a cell to be transitioned to a reduced power state, the identification of the cell based on a message from a radio access network intelligent controller application (rAPP), cause storage of information representing an initial power state of the cell, compute an intermediate power state for the cell, the intermediate power state intermediate a current power state of the cell and the reduced power state of the cell, cause a node to transition the cell to the intermediate power state, analyze a performance report from the node to detect a degradation in quality of service, and in response to the detection of the degradation in the quality of service, cause the node to revert the cell to the initial power state.

Example 9 includes the apparatus of example 8, wherein the message from the rAPP is based upon an inference from a machine learning model.

Example 10 includes the apparatus of any one or more of examples 8-9, wherein the at least one programmable circuitry is to, in response to the detection of the degradation in the quality of service, alert an operator of a communications network.

Example 11 includes the apparatus of example 10, wherein the message from the rAPP is based upon an inference from a machine learning model and the alert is to cause re-training of the machine learning model.

Example 12 includes the apparatus of any one of examples 8-11, wherein the at least one programmable circuitry is to compute the intermediate power state using reinforcement learning.

Example 13 includes the apparatus of any one of examples 8-12, wherein the at least one programmable circuitry is to initiate a timer after receipt of the message and cause the node to transition the cell to the reduced power state upon elapse of the timer.

Example 14 includes the apparatus of example 13, wherein the at least one programmable circuitry is to, prior to elapse of the timer, monitor the performance report to detect the degradation in the quality of service.

Example 15 includes an apparatus comprising means for identifying a cell to be transitioned to a reduced power state from a current power state, the identification of the cell based on a message from a radio access network intelligent controller application (rAPP), means for storing information representing an initial power state of the cell, means for computing an intermediate power state for the cell, the intermediate power state intermediate the current power state of the cell and the reduced power state of the cell, means for instructing a node to transition the cell to the intermediate power state, and means for analyzing a performance report from the node to detect a degradation in quality of service, wherein the means for instructing is to, in response to the detection of the degradation in the quality of service, instruct the node to revert the cell to the initial power state.

Example 16 includes the apparatus of example 15, wherein the message from the rAPP is based upon an inference from a machine learning model.

Example 17 includes the apparatus of any one or more of examples 15-16, means for instructing is to, in response to the detection of the degradation in the quality of service, alert an operator of a communications network.

Example 18 includes the apparatus of example 17, wherein the message from the rAPP is based upon an inference from a machine learning model and the alert is to cause re-training of the machine learning model.

Example 19 includes the apparatus of any one of examples 15-17, wherein the means for computing is to compute the intermediate power state using reinforcement learning.

Example 20 includes the apparatus of any one of examples 15-19, further including means for timing to initiate a timer after receipt of the message, and the means for instructing is to, upon elapse of the timer, cause the node to transition to the reduced power state.

Example 21 includes the apparatus of example 20, wherein the means for analyzing is to, prior to elapse of the timer, monitor the performance report to detect the degradation in the quality of service.

Example 22 includes a method comprising identifying a cell to be transitioned to a reduced power state from a current power state, the identification of the cell based on a message received from a radio access network intelligent controller application (rAPP), storing information representing an initial power state of the cell, computing an intermediate power state for the cell, the intermediate power state being intermediate the current power state of the cell and the reduced power state of the cell, instructing a node to transition the cell to the intermediate power state, analyzing a performance report from the node to detect a degradation in quality of service, and instructing, in response to the detection of the degradation in the quality of service, the node to revert the cell to the initial power state.

Example 23 includes the method of example 22, wherein the message received from the rAPP is based upon an inference from a machine learning model.

Example 24 includes the method of any one or more of examples 22-23, further including alerting an operator of a communications network in response to the detection of the degradation in the quality of service.

Example 25 includes the method of example 24, wherein the message received from the rAPP is based upon an inference from a machine learning model and the alert is to cause re-training of the machine learning model.

Example 26 includes the method of any one of examples 22-25, further including computing the intermediate power state using reinforcement learning.

Example 27 includes the method of any one of examples 22-26, further including initiating a timer after receipt of the message, and, upon elapse of the timer, causing the node to transition the cell to the reduced power state.

Example 28 includes the method of example 27, further including monitoring, prior to elapse of the timer, the performance report to detect the degradation in the quality of service.

It is noted that this patent claims priority from India Provisional Patent Application Number 202541035475, which was filed on Apr. 11, 2025, and is hereby incorporated by reference in its entirety.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory computer readable medium comprising instructions to cause at least one programmable circuit to at least:
identify a cell to be transitioned to a reduced power state, the identification of the cell based on a message from a radio access network intelligent controller application (rAPP);
cause storage of information representing an initial power state of the cell;
compute an intermediate power state for the cell, the intermediate power state intermediate a current power state of the cell and the reduced power state of the cell;
cause a node to transition the cell to the intermediate power state;
analyze a performance report from the node to detect a degradation in quality of service; and
in response to the detection of the degradation in the quality of service, cause the cell to revert to the initial power state.

2. The at least one non-transitory computer readable medium of claim 1, wherein the message from the rAPP is based upon an inference from a machine learning model.

3. The at least one non-transitory computer readable medium of claim 1, wherein the instructions are to cause one or more of the at least one programmable circuit to trigger an alert to an operator of a communications network in response to the detection of the degradation in the quality of service.

4. The at least one non-transitory computer readable medium of claim 3, wherein the message from the rAPP is based upon an inference from a machine learning model and the alert is to cause re-training of the machine learning model.

5. The at least one non-transitory computer readable medium of claim 1, wherein the instructions are to cause one or more of the at least one programmable circuit to determine the intermediate power state using reinforcement learning.

6. The at least one non-transitory computer readable medium of claim 1, wherein the instructions are to cause one or more of the at least one programmable circuit to initiate a timer after receipt of the message; and cause the node to transition the cell to the reduced power state upon elapse of the timer.

7. The at least one non-transitory computer readable medium of claim 6, wherein one or more of the at least one programmable circuit is to monitor the performance report to detect the degradation in the quality of service prior to elapse of the timer.

8. An apparatus comprising:
interface circuitry;
machine-readable instructions; and
at least one programmable circuitry to be programmed by the machine readable instructions to:
identify a cell to be transitioned to a reduced power state, the identification of the cell based on a message from a radio access network intelligent controller application (rAPP);
cause storage of information representing an initial power state of the cell;
compute an intermediate power state for the cell, the intermediate power state intermediate a current power state of the cell and the reduced power state of the cell;
cause a node to transition the cell to the intermediate power state;
analyze a performance report from the node to detect a degradation in quality of service; and
in response to the detection of the degradation in the quality of service, cause the node to revert the cell to the initial power state.

9. The apparatus of claim 8, wherein the message from the rAPP is based upon an inference from a machine learning model.

10. The apparatus of claim 8, wherein the at least one programmable circuitry is to, in response to the detection of the degradation in the quality of service, alert an operator of a communications network.

11. The apparatus of claim 10, wherein the message from the rAPP is based upon an inference from a machine learning model and the alert is to cause re-training of the machine learning model.

12. The apparatus of claim 8, wherein the at least one programmable circuitry is to compute the intermediate power state using reinforcement learning.

13. The apparatus of claim 8, wherein the at least one programmable circuitry is to initiate a timer after receipt of the message and, upon elapse of the timer, cause the node to transition the cell to the reduced power state.

14. The apparatus of claim 13, wherein the at least one programmable circuitry is to, prior to elapse of the timer, monitor the performance report to detect the degradation in the quality of service.

15. An apparatus comprising:
means for identifying a cell to be transitioned to a reduced power state from a current power state, the identification of the cell based on a message from a radio access network intelligent controller application (rAPP);
means for storing information representing an initial power state of the cell;
means for computing an intermediate power state for the cell, the intermediate power state intermediate the current power state of the cell and the reduced power state of the cell;
means for instructing a node to transition the cell to the intermediate power state; and
means for analyzing a performance report from the node to detect a degradation in quality of service, wherein the means for instructing is to, in response to the detection of the degradation in the quality of service, instruct the node to revert the cell to the initial power state.

16. The apparatus of claim 15, wherein the message from the rAPP is based upon an inference from a machine learning model.

17. The apparatus of claim 15, wherein the means for instructing is to, in response to the detection of the degradation in the quality of service, alert an operator of a communications network.

18. The apparatus of claim 17, wherein the message from the rAPP is based upon an inference from a machine learning model and the alert is to cause re-training of the machine learning model.

19. The apparatus of claim 15, wherein the means for computing is to compute the intermediate power state using reinforcement learning.

20. The apparatus of claim 15, further including means for timing to initiate a timer after receipt of the message, and the means for instructing is to, upon elapse of the timer, cause the node to transition to the reduced power state.
